(19) United States
(12) Patent Application Publication
(10) Pub. No.: US 2019/0095965 A1
(43) Pub. Date: Mar. 28, 2019

(54) SYSTEM AND METHOD TO DETECT SERVICE ASSIGNMENT OUTCOMES IN CONNECTION WITH ARRANGED SERVICES

(71) Applicant: Uber Technologies, Inc., San Francisco, CA (US)

(72) Inventors: Donald Stayner, San Francisco, CA (US); John Mark Nickels, San Francisco, CA (US); Peter Frazier, San Francisco, CA (US); Therese Lim, San Francisco, CA (US); Mayank Gulati, San Francisco, CA (US); Yuan Jiang, San Francisco, CA (US)

(21) Appl. No.: 16/142,985

(22) Filed: Sep. 26, 2018

Related U.S. Application Data
(60) Provisional application No. 62/563,618, filed on Sep. 26, 2017.

(51) Int. Cl. G06Q 30/02; H04W 4/029

(52) U.S. Cl. CPC G06Q 30/0282; H04W 4/029

(57) ABSTRACT

A computer system may record one or more service assignment outcomes of the first service provider over the service session interval, where each of the one or more service assignment outcomes are associated with the location of the first service provider at a time when that service assignment outcome occurred. The computer system may determine satisfaction score of the service session interval based at least in part on the recorded one or more service assignment outcomes. A remedial action may be performed in response to a determination of the satisfaction score not satisfying a threshold.

### RELATED APPLICATIONS

This application claims benefit of priority to Provisional U.S. Patent Application No. 62/563,618, filed Sep. 26, 2017, titled SYSTEM AND METHOD TO DETECT SERVICE ASSIGNMENT OUTCOMES IN CONNECTION WITH ARRANGED SERVICES; the aforementioned priority application being hereby incorporated by reference in its respective entirety.

### TECHNICAL FIELD

Examples described herein relate to a system and method to detect service assignment outcomes in connection with arranged services.

### BACKGROUND

Numerous on-demand services exist to offer users a variety of services: transportation, shipping, food delivery, groceries, pet sitting, mobilized task force and others. Typically, on-demand services leverage resources available through mobile devices, such as wireless (e.g., cellular telephony) devices, which offer developers a platform that can access sensors and other resources available through the mobile device. Many on-demand services include dedicated applications (sometimes referred to as “apps”) to communicate with a network service through which an on-demand service is offered.

### BRIEF DESCRIPTION OF THE DRAWINGS

FIG. 1 illustrates an example system to evaluate a service session interval of a service provider.

FIG. 2A illustrates an example method for implementing a service arrangement system to detect negative service assignment outcomes.

FIG. 2B illustrates an example method for providing forecasts of service provider objectives for an upcoming interval of time.

FIG. 3 illustrates a computer system on which one or more examples are provided.

FIG. 4 is a block diagram illustrating an example user device for use with examples as described.

### DETAILED DESCRIPTION

A computer system operates to determine a location of a service provider at multiple instances during the service provider's session interval. A computer system records one or more service assignment outcomes of the first service provider over a service session interval, where each of the one or more service assignment outcomes are associated with the location of the first service provider at a time when that service assignment outcome occurred. The computer system determines a satisfaction score of the service session interval based at least in part on the recorded one or more service assignment outcomes. In some examples, the computer system determines a remedial action to perform, in response to a determination of the satisfaction score not meeting a predetermined threshold.

In some examples, a computer system is provided in connection with a service to match service providers to service requests in a given geographic region. The system may obtain service signals correlating to a set of predefined objectives for service providers that are matched to service requests. The computer system responds to a forecast request from a service provider by determining a set of baseline expectation values for the service provider, where the set of baseline expectation values are based at least in part on the obtained service signals. The computer system may communicate the set of baseline expectation values to the service provider as forecast content.

As used herein, a client device, a driver device, and/or a computing device refer to devices corresponding to desktop computers, cellular devices or smartphones, personal digital assistants (PDAs), laptop computers, tablet devices, television (IP Television), etc., that can provide network connectivity and processing resources for communicating with the system over a network. A driver device can also correspond to custom hardware, in-vehicle devices, or on-board computers, etc. The client device and/or the driver device can also operate a designated application configured to communicate with the service arrangement system.

While some examples described herein relate to transport services, the service arrangement system can enable other on-demand location-based services (for example, a food truck service, a delivery service, an entertainment service) to be arranged between individuals and service providers. For example, a user can request an on-demand service, such as a delivery service (e.g., food delivery, messenger service, food truck service, or product shipping) or an entertainment service (e.g., mariachi band, string quartet) using the system, and the system can select a service provider, such as a driver, food provider, band, etc., to provide the on-demand service for the user.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Description

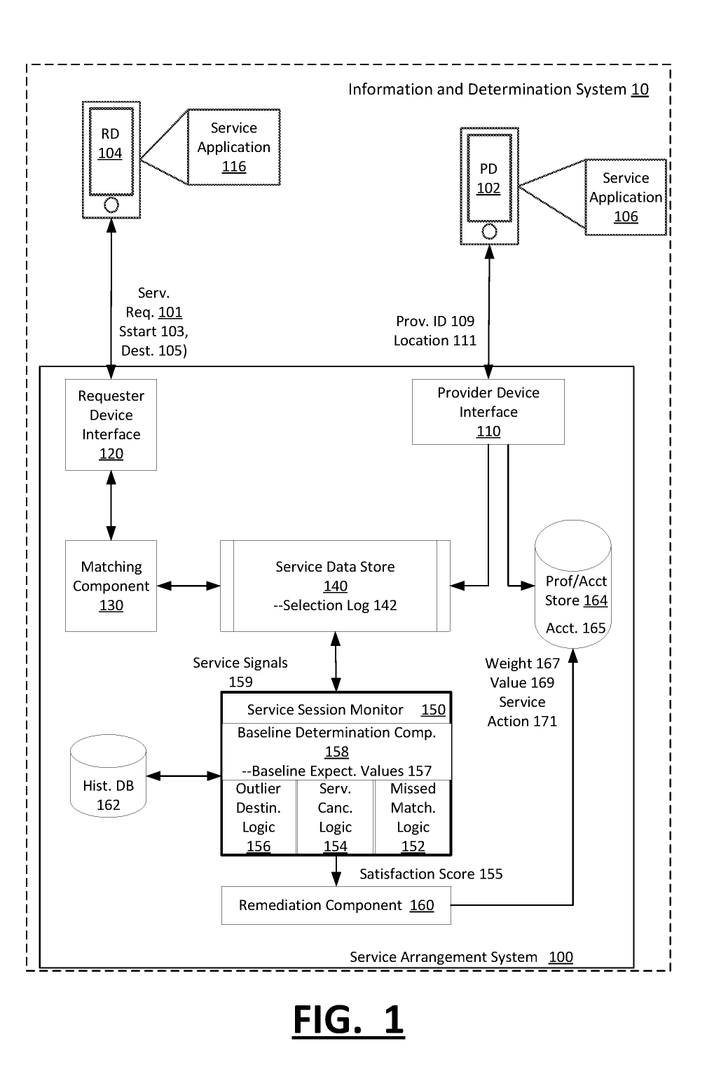

FIG. 1 illustrates an example system to evaluate a service session interval of a service provider. In some examples, system 100 includes functionality to detect service assignment outcomes that negatively impact objectives of service providers. According to some examples, a service arrangement system 100 includes functionality to detect negative service assignment outcomes which frustrate the objectives and experience of service providers, in connection with system 100 providing a network service to match service providers to service requests. The network computing system 100 can detect instances when, for example, a service provider is disproportionately impacted by one or more negative service assignments. Moreover, system 100 can implement operations to improve the service provider's outcomes, or otherwise facilitate the service provider's objective through remedial measures.

According to some examples, the network computing system 100 is implemented as a network service. Accordingly, the network computing system 100 may be implemented on, for example, one or more servers or other network computer machines. The network computing system 100 may be implemented as part of a transport arrangement service, which operates to match incoming transport service requests from requester devices with service providers who are available and in proximity to the start location of the service request. In variations, the network computing system 100 can be implemented as a separate or standalone service that can interface with a transportation arrangement service or user device (e.g., via a service application for the network service). Still further, in other variations, the network computing system 100 can be implemented at least in part on individual user devices. For example, functionality described with the network computing system 100 may be implemented as part of a service application that runs on mobile devices 102 of individual service providers.

The network computing system 100 may be implemented on a server, on a combination of servers, and/or on a distributed set of computing devices which communicate over one or more networks, including one or more types of cellular networks. In some examples, the network computing system 100 is implemented using mobile devices of users (shown in FIG. 1 as provider and requester devices 102, 104), with the individual mobile devices each executing a corresponding service application that causes the respective mobile device to operate as an information gatherer and/or outlet for the network computing system 100.

Accordingly, in some examples, the network computing system 100 can communicate with the provider and requester devices 102, 104 to receive information that is (i) specific to the location of each user, and (ii) contextual to reflect a real-world condition or event occurring at a particular time (e.g., a status of a service provider or requester), in regards to the user of the device 102, 104 from which information is gathered. As further described, the communications between the network computing system 100 and the provider and requester devices 102, 104 can be in the form of information sharing, as well as programmatic control (e.g., server of the network computing system causing a process on the respective user device to be triggered, and/or performed in a particular manner). In implementing programmatic control, the network computing system 100 can deliver, or alternatively utilize, scripts or other operative coding that reside on the particular device, so as to give the network computing system 100 presence on the particular device. In this respect, the network computing device 100 can implement, or alternatively utilize, a distributed architecture of devices, software components, or processes (which may exist temporarily or otherwise on the respective device). By way of example, the network computing system 100 (e.g., through use of one or more servers) can trigger an information gathering process to be performed on a respective provider or requester device 102, 104, where the executed process, when communicated on the particular device, causes the device to access other functionality, such as provided with a satellite receiver (or other location-aware resource), sensor (e.g., accelerometer, gyroscope, camera, microphone, etc.), application, or remote resource of that device (e.g., network information channel of the respective device). In this respect, the network computing system 100 can control when such information gathering processes are performed (such as in response to specific events and/or at a particular frequency), and under what circumstances information gathering processes are performed (e.g., after service provider toggles a user-interface feature to go online, and/or be available, or when a respective service application is launched on the user device). The network computing system 100 can also generate prompts for users, in response to information obtained from the user device, in order to obtain information that is specific to, for example, context and/or location of an activity that the user is performing and that is relevant to the transport arrangement service (e.g., service provider operating a vehicle).

Accordingly, in some examples, the network computing system 100 can, in combination with the provider and/or requester devices 102, 104, form an information and determination system 10, where the information and determination system 10 includes, for example, a network computer system (e.g., a logically centralized set of servers and/or server processes, including those of the network computing system 100), and a distribution of computing devices, where the distributed computing devices operate as information gathers, as well as outlets for determinations of the network computing system 100. As described further, the information gathered from the provider and/or requester devices can be utilized to make determinations that are predictive, specifically relevant to individual users, and instructive. In some examples, the network computing system 100 can implement outcomes, directly or indirectly, through communications of information and signals to provider and/or requester devices 102, 104. With regard to specific examples described, the network computing system 100 can generate, as outcomes, signals that when communicated to individual provider devices, cause, at least in aggregate (e.g., with respect to a group or population of service providers in a given region or sub-region), a desired distribution or redistribution of physical resources (e.g., service providers and their respective vehicles).

Still further, examples may provide for network computing system 100 to make determinations, and generate outcomes that further a particular objective of the network computing system 100. As described by examples, objectives of network computing system 100 can include arranging transport services (e.g., matching service providers to requests from requesters) in a manner that induces or otherwise encourages service providers to make themselves available for a transport arrangement service that is provided through the network computing system 100. To this end, the network computing system 100 can implement various processes that are intended to promote a particular number of service providers to be available. The processes can further be implemented to optimize the number of available service providers over various time periods, geographic regions and/or sub-regions.

The network computing system 100 can implement functions and processes to enhance the appeal of the transport arrangement service to a desired number of service providers. Under some conventional approaches, for example, the network computing system 100 implements randomness with specific processes, so that the transport arrangement service is provided fairly or non-discriminately to all service providers. For example, the network computing system 100 can implement a matching process (e.g., matching component 130) to match service providers to service requests using randomness by (i) selecting, for a service request, a candidate set of service providers, based on criteria of proximity of the service provider to a service start location, and (ii) selecting the service provider from the candidate set to receive an invitation or assignment, using randomness in part. In this way, when available service providers are considered in a given subregion or region and during a specific time interval (e.g., hour of a day), randomness can facilitate the substantially even distribution of service assignments with respect to count (e.g., a number of service requests assigned to a given service provider) and desirability. Thus, for example, randomness can facilitate the network computing system 100 in assigning a relatively same number of service assignments to a group of service providers, where the group is located or available to a given sub-region during a particular time interval. Further, randomness can facilitate even distribution of service assignments with respect to characteristics of desirability, where the characteristics of desirability map to service parameters such as destination of the service request 101, as well as length and/or duration of the service request 101.

Examples recognize that while the use of randomness in the matching process can further an objective of encouraging service providers to register (e.g., signup, open an account to provide services arranged through the network computing system 100) and/or be available for the transport arrangement service, randomness alone can have shortcomings with respect to the desired objective(s). Randomness in the matching process, for example, can result in statistical anomalies, where one service provider receives a disproportionate number of service assignments, or alternatively, a disproportionate number of undesirable service assignments. An experienced service provider will, over time, have such statistical anomalies balance out to a statistical norm. But a relatively new service provider may suffer from a poor experience at the beginning of their engagement with the transport arrangement service, because the new service provider may not recognize when a session interval is the result of a statistical anomaly (e.g., “bad luck”). Moreover, for some service providers, the bad session interval can have a greater impact than a good session interval.

In order to compensate for possible statistical anomalies in the distribution of service assignments, some conventional approaches utilize a historical parameter in combination with randomness, when implementing the matching process. The historical parameter can emphasize or deemphasize randomness during the matching process, in order to reflect, for example, a most recent time when the service provider received a service assignment, or alternatively, a number of service assignments a service provider received over a given period of time. However, the use of such historical parameters may not take into account what role the actions of the service provider had with respect to being matched to (or not matched to) service requests of the past. For example, a service provider may have a preference to locate (e.g., park vehicle) at a particular sub-region that has a relatively low service request rate, in which case that particular service provider should expect to receive service assignments at a lower rate than service providers who locate themselves in a more active sub-region. Examples further recognize that if the particular service provider relocates to the active sub-region, the use of a historical parameter for matching the service provider can result in an unfair outcome, as the historical parameter may only reflect the choice of the particular service provider, rather than the occurrence of a statistical anomaly.

Among other benefits, examples as describe improve upon such conventional approaches, by using a distributed information system as described, to distinguish instances where the relatively poor distribution of service assignments (either by quantity or quality) to a service provider is the result of a statistical anomaly, rather than the action of the given service provider. As described by various examples, in making the determinations, the network compiting system utilizes monitoring of service provider location and availability, as well as identification of other candidate service providers and other service assignment outcomes that involve the individual service provider (e.g., whether the service provider was assigned to a service request, which service provider received the request, etc.). Through use of a distributed quantity of service provider devices 102, examples provide that the network computing system 100 is able to gather sufficient information to determine the occurrence of statistical anomalies with respect to the service matching processes of the implemented transport arrangement service. In turn, some examples provide that the identification of statistical anomalies with respect to the distribution of service request assignments can improve the service matching process, by correcting against statistical anomalies that can otherwise result, even when randomness is employed. For example, intelligent weighting can be applied to service providers of candidate sets, to influence a selection process that also utilizes randomness, so as to reduce the impact of the statistical anomalies for affected service providers.

Moreover, in some examples, the system 100 implements functionality to provide service providers with information about expected service assignment outcome with respect to upcoming session intervals. Thus, for example, system 100 can provide a service provider with a forecast as to an expected number of service assignments, or an expected duration until the service provider is able to receive a service assignment. In examples, such forecasts can be determined through aggregation and analysis of information (e.g., location, availability, preference, service provider activity, etc.) as communicated by other provider devices 102 that are located in a relevant subregion during a relevant time period. In examples, the network computing system 100 further utilizes such forecasts to affect the location of the service provider receiving the forecast, so that the service provider locates or otherwise makes herself available for service requests that initiate in a sub-region where the service provider is more likely needed.

As further described by examples, the forecast provided to each provider can be location specific, such as specific to a region (e.g., city or portion thereof) or sub-region (e.g., quadrant of city, county, town, etc.) where the service provider is located at the time of the determination, or where the service provider is expected to be located (e.g., based on provider history, provider input, provider preference, etc.). The forecast can also be based in part on a service-type or product that a service provider is eligible for, with eligibility being determined by considerations such as (i) a service type that the service provider has agreed to provide, (ii) a service type that the service provider is capable of providing, and/or (iii) a service type that the service provider is eligible to provide (e.g., service provider is eligible for luxury service requests which are more lucrative for the service provider), or prefers to provide (e.g., service provider is eligible for luxury service requests, and prefers to provide luxury service requests over lower-priced services such as delivery services or pooled transport services).

As described in greater detail, system 100 can implement operations to objectively detect negative service assignment outcomes, using monitoring resources to eliminate situations where, for example, the service provider may be at fault for the negative service assignment outcome, or situations where the service provider's objective is not impacted significantly. System 100 can also implement comparative criteria through monitoring a population of service providers, in order to detect when the impact of a negative service assignment is disproportionate as compared to the experience of other service providers.

In an example of FIG. 1, the network computing system 100 is shown to be in communication with each of a provider device 102 and requester device 104, representing devices operated by respective provider class users (e.g., drivers) and requester class users (e.g., riders) of a given population. Each provider device 102 and/or requester device 104 operates a corresponding service application 106, 116 implemented through execution of instructions stored in one or more memory resources of the computing device. The service applications 106, 116 may correspond to programs (e.g., a set of instructions or code) or applications (e.g., ‘apps’) that are downloaded and stored on the computing devices of the respective users. With reference to FIG. 1, the service application 106 executes on the provider device 102 to transmit information that includes the provider's identifier 109 and the provider's location data 111. Likewise, the requester device 104 can execute the service application 116 to transmit the requester's identifier and the requester's current location. Additionally, the requester can operate the requester device 104 to make a service request 101 that specifies service parameters, such as a service start location 103, destination 105, or other parameters (e.g., service type).

In an example of FIG. 1, system 100 includes a provider device interface 110, a requester device interface 120, a matching component 130, and a service data store 140. The provider device interface 110 can establish a network connection with the provider device 102, via execution of the corresponding service application 106. The provider device interface 110 may receive provider data (e.g., provider identifier 109, provider's current location 111) using the network connection. In one implementation, the provider device interface 110 can establish a connection with multiple provider devices 102 concurrently, with the connection to each provider device using one or more wireless networks (e.g., wireless networks, such as a cellular transceiver, a WLAN transceiver, etc.).

Each of the provider and requester device interfaces 110, 120 can include or use an application programming interface (API), such as an externally facing API, to communicate data with one or more provider devices 102 and requester devices 104, respectively. The externally facing API can provide access to the provider device 102 via secure access channels over the network through any number of methods, such as web-based forms, programmatic access via RESTful APIs, Simple Object Access Protocol (SOAP), remote procedure call (RPC), scripting access, etc.

In some examples, a service provider may operate the service application 106 to initiate a service session with the network computing system 100, during which the service provider is available for assignment to service requests. For example, the service provider may initiate a service session interval by toggling a user-interface feature of the service application 106. The service session interval may correspond to any continuous duration of time in which a service provider makes himself or herself available to system 100, in order to receive assignments (e.g., matched service requests) and to provide services (e.g., transport services) in connection with assigned service requests. Over the course of a service session interval, the service provider is available to receive assignments from system 100. In such examples, the times when the service session interval of the service provider starts and terminates may thus be selected by the service provider.

When the service provider initiates the service session interval, the service provider's identifier 109 and current location 111 are communicated to the network computing system 100 via the provider device interface 110. The provider device interface 110 may record the service provider identifier 109 and the provider's current location 111 with the service data store 140. The service data store 140 may also associate the service provider with a service state of available, indicating the service provider is available to receive service requests. As the service provider operates their respective vehicle, the service application 106 may continue to transmit the current location 111 of the service provider to the provider device interface 110, and the provider device interface 110 updates the current location of the service provider with the service data store 140.

According to some examples, requesters operate service applications 116 on respective mobile devices (represented by requester device 104) to submit service requests 101. The requester device interface 120 may receive, for example, a given service request 101 from requester device 104, where the service request 101 specifies one or more service parameters. The service parameters may correspond to, for example, service start location 103 and destination 105, as well as other parameters such as a service type. When the requester submits the service request 101, the service request may be deemed open until the service request is matched to a service provider (e.g., service provider accepts the service request). In some variations, the service provider may also be able to cancel a service request 101, subject to one or more rules or conditions. For example, the requester may be able to cancel a service request 101 at any time preceding when a service provider is matched, or within a designated duration of time after making the service request 101. As another example, the requester may cancel the service request subject to a cancellation penalty.

The service request 101 may be received by the requester device interface 120 and forwarded to the matching component 130. The matching component 130 may implement a process to assign or match the service request to a service provider. Once the matching component 130 matches an available service provider to a service request 101, the matching component 130 may change the state of the service provider from available to assigned. The provider device interface 110 may communicate information about the matched service request to the corresponding provider device 102. When the provider is matched, the corresponding provider device 102 may receive the service start location 103, as well as routing information to navigate the service provider from the provider's current location 111 to the service start location 103. The provider device 102 may also receive other types of information to initiate service for the matched service request 101. For example, the provider device 102 may receive information such as identification information for the requester (e.g., first name of requester), and/or profile information (e.g., rating of requester).

When the service request 101 of the requester device 104 is matched to the provider device 102, the matching component 130 may trigger the requester device interface 120 to provide the requester device 104 with information about the matched service provider. The service provider information may include, for example, identification information about the service provider (e.g., provider name, picture), information about the vehicle or type of the service provider, the service provider's rating, and the service provider's estimated time of arrival (or other forms of progress information, showing the service provider's arrival to the service start location). According to some examples, the service application 116 of the requester device 104 may display features to enable the requester to cancel the service request before the arrival of the service provider to the service start location. The cancellation may be subject to rules, including a set of rules to determine whether the requester is charged for the cancellation, as well as a second set of rules that identify the amount of service charge for a cancellation. For example, the network computing system 100 may implement a rule where no service charge is applied against the account of the requester provided that the requester makes the cancellation within a designated period of time from when the service request was made.

The provider device interface 110 may continue to update the service data store 140 with the current location 111 of the service provider as the service provider travels to the service start location 103 and then to the destination 105. For example, the service application 106 may repeatedly access a local resource (e.g., GPS) of the provider device 102 to obtain the current location. In some example, a service session monitor 150 monitors the service data store 140 to update the service state of the service provider by detecting when the service provider arrives at the start location 103 and/or the destination 105. The service provider may also operate the service application 106 to manually indicate when an assigned service request is started, completed or terminated. When a service start or completion is detected (e.g., through input provided by the service provider), the service session monitor 150 may change the service state of the service provider accordingly, such that the service data store 140 reflects the updated service state.

In some examples, system 100 defines multiple possible states for service providers. By way of example, a service provider state may correspond to (i) available and unassigned, (ii) on-route to service location, and (iii) on-trip to service destination. In variations, the network computing system 100 may maintain additional service states that indicate availability and non-availability of the service provider. In one variation, the service data store 140 may monitor for additional service provider states, such as, for example, on-route and available, coinciding with the service provider being assigned to a service request and being directed to the service start location, while being subject to possible reassignment if another service request is received that is deemed to be a better match. The on-route and available state may correspond to a threshold duration of time (e.g., two minutes) that immediately follows the assignment of a service provider to a service request, during which the service provider may be reassigned. As another example or variation, the service data store 140 may track a service provider that is on-trip to detect a trigger (e.g., service provider reaches a threshold proximity to the destination, as measured by distance and/or time. Once the trigger is detected, the service provider may be switched from a state coinciding with being on-trip to a state of being on-trip and available. When in the on-trip and available state, the matching component 130 may assign the service provider to a new service request, based on an anticipated completion time and/or destination of the service provider's current trip.

In some examples, the matching component 130 assigns an incoming service request 101 to a service provider based on selection criteria that includes a proximity of the service provider's current location 111 to the service start location 103 of the service request 101, and a service state of the service provider (e.g., available, on-route and available, etc.). In some variations, the matching component 130 may also implement an aggregate optimization based on an objective such as reducing overall wait times for an aggregation of open service requests 101. In some examples, open service requests 101 may be queued for a given duration (e.g., 1 minute) in pre-defined sub-regions, and then the matching component 130 may carry out matching of service requests in accordance with the optimization objective. In such implementations, the matching component 130 may assign service requests 101 to service providers to promote the objective of the aggregate, and the outcome of the matchings of the queued service requests may be different than if the service requests were matched individually to service providers. In the latter case, each service request may be matched to a service provider based on, for example, a determination of the service provider that is most proximate the service start location 103 of the service request 101. The outcomes of the matching component 130 for a given set of service requests 101 may thus differ based on, for example, the selection process that is used by the matching component 130.

Still further, the matching component 130 may match a service provider to a service request by first identifying a set of candidate service providers. The candidate service providers may, for example, correspond to those service providers who satisfy a first set of criteria, such as availability (e.g., based on service state) and proximity (e.g., current location of service provider is within sub-region, or within a threshold distance of where a service request was received). In some variations, the candidate set of service providers may be ranked or pre-ranked, based on criteria that may include one or more of an arrival time of service provider to the service start location 103 of the corresponding service request 101, distance that is to be traveled by the service provider to the service start location 103, and/or type of service (e.g., luxury vehicle versus sedan) which the requester may prefer. Still further, randomness can be used to select from the candidate set of service providers.

As an addition or variation, the ranking of the service provider may also be based on an optimization outcome. For example, the optimization outcome may be based on reducing an overall wait time amongst a group of requesters and their respective service requests. The ranking of the service providers may thus be based on the group optimization, and may further be in flux based on, for example, the service start locations of newly received service requests.

As shown by various examples, numerous factors may affect the outcome of the matching component 130, and over the course of a given duration, such random factors may have a disproportionate impact on a relatively small number of service providers. According to some examples, the network computing system 100 may determine that a given service provider is “unlucky” when the service provider is subject to an extended duration of an unwanted service outcome, even in situations where the extended duration is not attributable to the service provider (e.g., the service provider is well-positioned during a time of high demand, but experiences an extended duration without being assigned to a service request). As described by some examples, system 100 may recognize a first type of situation which may affect a portion (e.g., 5%) of the active service providers in a given time interval (e.g., hour of day). The network computing system 100 may recognize a negative service assignment outcome in one or more situations where the given service provider is a highly ranked or viable candidate for assignment to a service request. In particular, the network computing system 100 may recognize the negative service assignment outcome when predefined criteria is met, such as an extended duration in which the service provider is a highly ranked candidate for multiple service requests, but is not selected for any of the service requests. As an addition or alternative, the negative service assignment outcome may be recognized after, for example, (i) repeated occurrences, (ii) repeated occurrences without an intervening assignment, and/or (iii) a disproportionate number of such negative service assignment outcomes, as compared to a baseline expectation (e.g., average amongst other service providers operating in the same sub-region, historical values, etc.).

As described by some examples, the recognition of negative service assignments being ‘unlucky’ for individual service providers can be made by defining the parameters of the negative service assignment, and then determining when a particular service provider receives a statistically anomalous (e.g., below a standard of deviation) number of negative service assignments and/or no service assignments. In such examples, the statistical determinations can be made with respect to an aggregation of data, collected in part from information communicated by provider devices 102 with respect to service assignments and availability, and with specific reference to a relevant sub-region and time. In variations, the recognition of negative service assignments can be based on comparative thresholds (e.g., no more than three per day). Still further, the definition of negative service assignments can be location-specific, time-specific, and/or provider-specific. For example, the determination of negative service assignments can consider a distance traveled for the service assignment, and the distance can be varied based on the sub-region where, and/or the time period (e.g., time of day) when the service request starts. Still further, the definition of the negative service assignment can be specific to the types of service or services that the service provider is eligible to provide.

Accordingly, the determination of when negative service assignment outcomes occur can be based on the location of the service provider at the time of the occurrence. For example, the negative service assignment outcome may not be recognized if the service provider is in a low-demand service area. The criteria for determining when such negative service assignment outcomes occur, as well as whether the impact of such service assignment outcomes exceeds a threshold (e.g., as described below) may be based in part on the location of the service provider. For example, the determinations may be based on a relative comparison to the experience of other service providers who operated in the same sub-region during the same time period or in recent history.

In some examples, the determination of the negative service assignment outcome is isolated to instances in which fault is not attributable to the service provider. The service provider may, for example, be a candidate for selection that is passed over for a service request because of the service provider's relative location to a given service start location differs from another service provider's location by a fraction of a kilometer. As an addition or variation, the service provider may be passed over with respect to a given service request because multiple new and proximate service requests may be received at once which impact the selection process (e.g., optimized selection process). As described in greater detail, system 100 may be implemented to recognize situations where, over an extended portion of time (e.g., several hours), some service providers may be repeatedly passed over for service requests, despite being viable or highly ranked for matching to such service requests.

Still further, in some cases, a service provider may be matched to a service request that is unwanted, or detrimental to a desired outcome of the service provider. By way of example, the service provider may receive a service request in which the destination is remote, located in a low-demand area (e.g., where a service provider is unlikely to receive a return fare to high-demand service area), and/or in a region that the service provider does not want to be in (e.g., service provider may be unfamiliar with sub-region, and unable to efficiently operate vehicle). The occurrences of such service assignments may result in, for example, the service provider achieving less of a desired outcome. By way of example, the occurrence of such outcomes may reduce the time during which the service provider is actively providing service.

According to some examples, system 100 may implement functionality to detect instances in which service providers suffer a disproportionate impact from one or multiple service assignment outcomes during a given interval of time (e.g., session during which service provider is available for matching to service requests). By way of example, the types of service assignment outcomes which may be detected and evaluated for their respective outcomes may include, for example, one or more instances over the course of a given time interval, in which the service provider (i) is a likely or viable candidate for selection to a service request that is subsequently assigned to another service provider (“just-missed service assignments”); (ii) receives an undesirable service request (e.g., a service request that has a short duration); (iii) receives a cancellation of an assigned service request, through no fault of the service provider; and/or (iv) receives a service request that has an undesirable service parameter. In examples, a service assignment outcome may be predefined, based on, for example, an objective determination that an outcome of a service assignment event is detrimental to an objective of the service provider. For example, the objective of the service provider may correspond to a duration of time during which the service provider is providing service (e.g., with a passenger in the vehicle).

According to some examples, the service session monitor 150 includes a baseline determination component 158 which can determine one or more types of baseline expectation values 157 with respect to at least one objective of a given service provider and/or a measure of a service assignment outcome. The baseline expectation values 157 may be predefined and based on service assignment outcomes (e.g., number or frequency of service assignment outcomes). For example, the baseline expectation values 157 may correspond to (i) an expected amount of service time which the service provider can expect to receive, (ii) the number of service requests the service provider may receive in a given time interval, (iii) an expected frequency for service requests that are assigned to the service provider (e.g., expected time between service requests, or to a next service request), and/or (iv) a time until the service provider receives a next service request. The baseline determination component 158 may determine the baseline expectation values 157 for service providers to be specific to the respective location of the service provider (e.g., geographic sub-region of the service provider), as well as the time or duration over which the expectation is to be made.

The baseline determination component 158 can determine the baseline expectation values 157 using a set of service signals 159, as determined from the service data store 140. For example, the service data store 140 may be used to determine service signals such as (i) the average time between service requests for service providers that are located within a sub-region of the service provider (and over a relevant time period), (ii) the aggregate number of service requests received or fulfilled by service providers who share the same sub-region of the service provider, or who have similar location profiles over a past duration, (iii) the number of service providers (or available service providers) which are located with the sub-region of the service provider, and/or (iv) the number of active requesters, including the number of open requests, and/or the number of requesters who may soon be ready to make a service request (e.g., service requesters who have a service application open for generating a service request). In variations, additional service signals 159 may include traffic conditions (e.g., amount of congestion on the road), weather conditions (e.g., less service requests may be received in inclement weather), or presence of events where requesters or providers may be conglomerated (e.g., sub-region includes public concert). Still further, the relevant service signals 159 can be specific to the type of service or services that the service provider is eligible to provide (e.g., based on experience, ranking, vehicle type, etc.). Additionally, in some variations, forecasted expectation values 157 may be weighted for a particular service provider based on provider-specific information, such as the performance of the service provider over time with respect to receiving and/or fulfilling service requests.

As an alternative or variation, the baseline determination component 158 may utilize historical values to determine the baseline expectation values 157. In an example of FIG. 1, the baseline determination component 158 accesses a historical service store 162 to determine historical service signals. For example, a snapshot or other copy of the service data store 140 can be made repeatedly over time, and then parsed for metrics that correspond to service signals. In this way, the historical service store 162 can provide historical versions (or aggregations thereof) of the service signals 159, which the baseline determination component 158 can use to generate the baseline expectation values 157 for individual service providers, based on the time interval (e.g., day of week, time of day, etc.) and the location of the service provider.

In some variations, the baseline determination component 158 can utilize models to generate forecasts that are based on the baseline expectation values 157. For example, the baseline determination component 158 can use a linear regression model to determine forecasted expectation values. In some variations, the models used for baseline determination component 158 can be trained using historical values from the historical service store 162.

In some examples, the baseline expectation values 157 may be communicated to the service provider via the service provider device interface 110. By way of example, the service provider may utilize an interface provided by the service application 106 to determine what the service provider can expect over an upcoming interval of time, with respect to one or more of (i) a time until the service provider is assigned to a next service request, (ii) a number of service requests which the service provider can expect to receive in a given interval of time, (iii) an amount of service time or earnings which the service provider can receive over an upcoming interval of time.

As described with some examples, the baseline expectation values 157 may be specific to a current or expected location of the service provider when the determination is made. Thus, in some examples, the expectation values 157 that are communicated to the service provider can change, or be dynamic, with movement of the vehicle. For example, the service application can repeatedly updated one or more baseline expectation values 157 (e.g., expected time until the service provider receives a next service request, an expected earnings of the service provider for a given time interval) as the service provider travels in his vehicle. In this manner, the baseline expectation values 157 can be communicated to instruct and/or encourage the service provider to reposition herself in a location where the service provider is more likely to be needed.

In variations, the baseline expectation values 157 may also be based in part on a type of service, or services, that the service provider is eligible to receive. For example, the service provider's eligibility to receive service request assignments for services of a particular type may be based on the vehicle type of the service provider, as well as other considerations such as the overall rating of the service provider. A service provider that is eligible to receive service requests that are more lucrative (e.g., luxury transport requests) can, for example, expect to receive fewer service request assignments. Accordingly, the service baseline expectation values 157 that are communicated to service providers who are eligible to provide multiple types of services can include different sets of baseline expectation values 157 for individual service types.

The network computing system 100 may also utilize the baseline expectation values 157 to provide the service provider with information for a future time interval (e.g., upcoming hour). In turn, the service provider may use the information to determine, for example, whether the service provider should continue to be available or stay online (e.g., if earning potential is relatively poor, the service provider may choose to not be available), or whether the service provider should change sub-regions in order to increase their earnings potential. Alternatively, the service provider can view baseline expectation values 157 for a past interval in order to compare his or her outcome (e.g., earnings, or number of service assignments) to an expectation that is based on an aggregation from other service providers.

As an addition or alternative, the baseline determination component 158 can generate the baseline expectation values 157 for a given time interval (e.g., past hour or past 4 hours) in order to provide a point of comparison for the service assignment outcomes which the service provider actually received. As described in greater detail by other examples, if such comparisons fall below a given threshold, then the service monitor 150 may also implement a remedial measure for the service provider.

According to examples, the occurrence of the service assignment outcome may be deemed to have a disproportionate impact to a given service provider based on a comparison of the service provider's objective to a baseline expectation value 157. The baseline expectation value 157 may be based on an aggregate (e.g., average, median, weighted average) objective of service providers during a same interval, or historically over a recent date range. For purpose of comparison, the baseline expectation value 157 may be relevant to service providers in the same location (e.g., same city block, within a threshold distance (e.g., 250 feet)) as where the occurrences took place.

With reference to an example of FIG. 1, the service session monitor 150 monitors the service data store 140 for occurrences of service assignment outcomes. Based on detected service assignment outcomes, the service session monitor 150 determines a satisfaction score 155 for the service provider's session interval, or portion thereof. The satisfaction score 155 may reflect (i) the correlation between detected and expected service assignment outcomes, and/or (ii) an impact of the occurrence of a service assignment outcome. The service session monitor 150 may employ a predefined definition of a service assignment outcome, such that the satisfaction score 155 may reflect a quantity (e.g., a count or magnitude) of a predefined service assignment outcome, as detected by the service session monitor 150, when compared to an expected quantity. In some examples, the predefined service assignment outcomes are negative (e.g., “negative service assignment outcome”), meaning the occurrence of such outcomes thwart an objective of the service provider (e.g., to earn income). By way of example, the service session monitor 150 may define and monitor for the occurrence of negative service assignment outcomes that include one or more of (i) an instance when a service provider is a likely or viable candidate for selection to a service request that is assigned to another service provider (“just-missed service assignments”); (ii) an instance when the service provider receives an undesirable service request (e.g., a service request that has a short duration); (iii) an instance when the service provider receives a cancellation of an assigned service request, through no fault of the service provider; and/or (iv) an instance when the service provider receives a service request that has an undesirable service parameter (e.g., destination is in an area that is undesirable or detrimental to the objective of the service provider).

In determining the occurrences of service outcomes, the service session monitor 150 can also implement a heuristic model or system to detect criteria that are used to define service assignment outcomes, including events which constitute negative service assignment outcomes. The service session monitor 150 may tune the model for specific geographic regions, users, or class of users. The models used by the service session monitor 150 may be trained in part by soliciting feedback from service providers about specific events, and by statistically analyzing the impact of defined events relative to a comparative baseline (e.g., a corresponding expectation value 157). In many cases, the comparative baseline may be defined to include the experience of other service providers who are in the same geographic region of the service provider, as well as service providers operating during a relevant time period (e.g., at same time, or previously at same day of week and time).

According to examples, the service session monitor 150 may determine the satisfaction score 155 based on a count (e.g., number of instances when a predefined service assignment outcome is detected during the service session of the service provider). In some variations, the count may also be time-based, to reflect, for example, a rate of the number of instances, or the number of instances in a given duration of time. As an addition or variation, the satisfaction score 155 may be based on an effect which the detected service assignment outcome(s) have on an objective of the service provider with respect to the service session. For example, the service session monitor 150 may determine whether a predefined service assignment outcome negatively impacts the service provider's objective to a degree that results in one of the service provider's objectives (e.g., portion of time during which service provider is providing service) falling below a threshold, where the threshold is based on the corresponding expected baseline value 157.

The service objective may also include subjective objectives which are learned from, for example, input by the service provider. The subjective input may, for example, identify preferences and dislikes of the service provider. For example, the service provider's objective may include a personal dislike for providing service that passes through a given sub-region. For the particular service provider, the service session monitor 150 may determine the number of instances in which the service provider is assigned to a service request that routes the service provider through the disliked sub-region.

In some examples, the satisfaction score 155 may reflect a binary (e.g., “satisfactory” and “unsatisfactory”) or trinary value (e.g., “satisfactory”, “neutral” or “unsatisfactory”). In some variations, the satisfaction score 155 may reflect additional values, such as a score between a maximum and a minimum. In such examples, the correlation between the quantity of the negative service assignment outcome(s) and the satisfaction score 155 may be based on thresholds. For example, if Y (e.g., 3) negative service assignment outcomes are detected for the service provider in a given time (e.g., one hour), the satisfaction score 155 may reflect an unsatisfactory score or value. Still further, as described below, the satisfaction score 155 may be heuristically determined. Additionally, the correlation of the satisfaction score 155 to the expectation (e.g., expected baseline) may be based on factors such as (i) detection of comparable negative service assignment outcomes for other service providers, (ii) historical data for the service provider and/or class of service providers in the given region, and/or (iii) detected factors that sufficiently attribute a service assignment outcome that is unwanted to the service provider.

In some examples, the service session monitor 150 processes the data of the service data store 140 in order to determine when predefined service assignment outcomes occur for individual service providers. The service session monitor 150 may include missed matching logic 152 to detect and count service assignments which individual service providers just-missed (i.e., just-missed service assignments). The missed matching logic 152 may employ a set of rules that define the occurrence of just-missed service assignments. As described with other examples, the missed matching logic 152 may compare the determined count of just-missed service assignments to the number of service assignments which a service provider did receive. As an additional variation, the missed matching logic 152 may detect only those instances in which a service provider is deemed to have just-missed receiving a service assignment. The determinations may include consideration of counter-events which remediate the impact of the negative service assignment outcome. For example, if the service provider is deemed to have just-missed a service request, only to immediately receive a service assignment, the occurrence of the just-missed service match may be disqualified or ignored.

In some variations, the matching component 130 generates assignment logs 142 which are distributed to records associated with individual service providers. For individual service requests 101, the assignment logs 142 may identify service providers which were alternatives to the selected service provider. For example, the matching component 130 may utilize a matching process in which 5 candidate service providers are determined from an available pool of service providers. The top 5 candidate service providers may be ranked, and the determination of which service provider is assigned to the given service request 101 may be based in part on whether the highest ranked service provider accepts the service request. When the service provider selection is made by the matching component 130, those service providers who were one of the candidate set (but who did not have an opportunity to accept the service request) may be identified by the assignment logs 142 of the service data store 140. The missed matching logic 152 may use the assignment logs 142 to count occurrences of just-missed service assignments amongst service providers over a given timeframe. Additionally, the missed matching logic 152 may include rules to discount or ignore occurrences of just-missed service assignments, in order to distinguish occurrences which were bad luck or unfortunate to the service provider from those which were expected or through the fault of the service provider. For a given service provider, the missed matching logic 152 may correlate, for example, an incidence of a just-missed service assignment to a location of the service provider when the occurrence occurred. The location of the service provider at the time when the just-missed service assignment occurred may distinguish occurrences which are bad luck from those that are attributable to the service provider. In this way, the missed matching logic 152 may discount or ignore a just-missed service assignment that occurs when the service provider is located in a low or moderate demand region. However, the missed matching logic 152 may record a just-missed service assignment occurrence, or a series of such occurrences for a given service provider who is located within a high-demand region.

In some examples, the service session monitor 150 includes service cancellation logic 154 to detect and record occurrences of a service provider being assigned to a service request that is canceled by the requester. As an addition or alternative, the service cancellation logic 154 may detect and record occurrences of a service request that is terminated prematurely. The service cancellation logic 154 may enable the service session monitor 150 to process data from the service data store 140 to identify conditions or events which indicate a cancelation or termination is (or is not) attributable to the service provider. By way of example, the service session monitor 150 may implement the service cancellation logic 154 to determine a duration of time between when the service provider is assigned to a request and when the service provider begins to travel towards the service start location of the assigned service request. If the service provider takes unnecessary time to begin traveling towards the service start location, the occurrence of a service request cancellation may be attributed to the service provider. In some examples, the service session monitor 150 may record the cancellation of an assigned service request that is not attributable to the service provider as being an undesired (or negative) service assignment outcome.

As an additional variation, the service session monitor 150 may include outlier destination logic 156 to identify occurrences when a service provider is detrimentally repositioned as a result of an assigned service request. By way of example, the outlier destination logic 156 may be used to detect when a service provider is assigned to a service request that results in the service provider being transported from a high demand sub-region to a relatively low-demand area that is deemed remote (e.g., more than a threshold distance, such as 20 miles (or 44 kilometers)). For example, while a destination that is far from the current location of the service provider may provide a good fare value by itself, the location of the destination and the low demand nature of the sub-region may limit the ability of the service provider to be assigned to a service request that returns the service provider to a high demand region. Thus, for example, the service provider may have to drop-off a requester at the destination, then travel back towards a high demand sub-region without an accompanying fare. In some cases, the act of traveling back to a high-demand sub-region without an accompanying fare can be sufficiently detrimental to the overall objective of the service provider (e.g., maximize assigned service time) to outweigh the benefit of the high fare value from the original assignment. According to some examples, the outlier destination logic 156 may include a list of sub-regions which are undesirable as destinations, or otherwise likely to result in no return fares. The service session monitor 150 may use the outlier destination logic 156 to identify service parameters of recently fulfilled service requests, or service requests that are being fulfilled, where the service start location 103 and/or destination 105 match predetermined or selected sub-regions. In particular, the outlier destination logic 156 may utilize geofencing or other geographic designations to identify regions which are undesirable or detrimental to service provider objectives.

With respect to examples provided, the satisfaction score 155 may be based on a count of the number of times a corresponding service assignment outcome occurred over a given duration (e.g., hour) or service provider session. The determination of the satisfaction score 155 may also be based on subsequent service assignments. For example, if a service request cancellation is followed immediately by a service assignment for the service provider, the satisfaction score 155 may reflect the occurrence of the service request cancellation as a non-event.

As an alternative or variation, the satisfaction score 155 may be based on a magnitude or severity of the negative service assignment outcome. For example, the service session monitor 150 may implement the missed matching logic 152 to determine when the service provider goes through an extended period of misfortune or bad luck, in regard to the service provider just-missing a service assignment despite being positioned in a high-demand area, while other service providers in the same sub-region receiving a comparably greater number of service assignment requests.

In some examples, the service session monitor 150 determines an effect of a service provider outcome on an objective (e.g., total length of service time, revenue, etc.) of the service provider. For example, if N negative service assignment outcomes are detected for the service provider in a given time period, and the service provider's objective fails to meet an expectation (e.g., average amongst all service providers), then the satisfaction score 155 for the service provider's session may reflect a determination that the service provider's session (or portion thereof) was unsatisfactory.

In some examples, the service session monitor 150 determines the satisfaction score 155 based on the quantity of the detected negative service assignment outcome. For example, the service provider's session may be deemed unsatisfactory (e.g., satisfaction score 155 fails to meet satisfaction threshold) when the determined count of a particular type of negative service assignment outcome exceeds a predetermined threshold. As another example, the service session monitor 150 may determine the satisfaction score 155 based on a number of “just-missed service assignment outcomes” of the given service provider, as compared to a number of assigned service requests which the service provider received over the duration of the service session.

In some variations, the service session monitor 150 determines the satisfaction score 155 based in part on an impact level or magnitude of a negative service assignment outcome. In particular, some types of negative service assignment outcomes may have a greater detrimental impact to the service provider's objective. In some examples, the impact of a negative service assignment outcome may be measured from a comparison of the service provider's objective to an expected baseline. The service session monitor 150 may quantify the service provider's objective over the duration in which a negative service assignment outcome is detected. For example, a service provider may receive an assignment that requires the service provider to travel a relatively long distance or time to reach a service location. While on-route to the service start location, the service provider may be delayed by traffic, causing the service request to be canceled by the requester. In such a scenario, the service provider can remain in traffic for an extended period of time. The service session monitor 150 may detect the negative service assignment outcome (or the cancelation), and then determine the duration in which the service provider was impacted by the cancelation (which in the scenario provided, is exasperated by congestion). The impact of the negative service assignment outcome (e.g., stemming from the cancellation) may be determined by, for example, a time interval beginning with the assignment of the service provider to the service request which was subsequently canceled and the cancelation of the service request. However, in some examples, the detrimental impact of the service request cancellation may be based on the continued measuring of time until, for example, the service provider is able to receive and/or arrive at another service start location, so as to account for the service provider's delay from congestion.

As an addition or variation, detrimental impact stemming from a predefined service assignment outcome may be measured from the time in which the service provider is assigned to the service request that is canceled, until when the service provider returns to his home region (e.g., region where service provider is most likely to be while available). Still further, as another measure of impact, the objective of the service provider following the cancelation (or for the entire duration of the service provider session) may be measured and compared to objective criteria, such as the historical average of the service provider, or comparable results for other service providers who were in the same region as the service provider. The measurement of the service provider's objective may be in terms of, for example, (i) the time (e.g., number of minutes) in the service provider session during which the service provider was actively engaged and providing service; (ii) the distance driven by the service provider when providing service; and/or (iii) the service provider's earnings.

According to some examples, the satisfaction score 155 may be normalized, based on the location history of the service provider, particularly when negative service assignment outcomes are detected. For example, the service session monitor 150 may discount or ignore at least some types of negative service assignment outcomes based on the location of the service provider when the service provider received the assignment. In such examples, the satisfaction score 155 may reflect lost-opportunity for the service provider. The sub-region where the service provider is located may include a low volume of requesters, such that the occurrence of a negative service assignment outcome for a service provider who voluntarily (e.g., on his own volition) locates in that sub-region can be assumed to have relatively little opportunity cost.

While the network computing system 100 may determine negative service assignment outcomes based on set of objective criteria, in variations, negative service assignment outcomes may also be based on subjective considerations. In some examples, the service provider may be prompted (e.g., via the service application 106) to provide input to indicate positive and negative sentiment about different aspects of the provider's session. For example, through the feedback interface, the service provider may provide input that indicates the service provider's sentiment that certain sub-regions are undesirable for service assignments. These sub-regions may be associated with, for example, unfamiliarity to the service provider (e.g., service provider may become lost and lose income), low earning potential, difficulty in navigation, low chance of return fare, or other considerations. The service session monitor 150 may define a negative service assignment outcome based on the feedback of the service provider. For example, if the service provider receives an assignment to a sub-region which the service provider has previously indicated via feedback as being undesirable, the satisfaction score 155 for the service provider may be updated to reflect the negative service assignment outcome.

According to some examples, the network computing system 100 includes a remediation component 160 to select and/or implement a remedial action for individual service providers, based on the respective satisfaction score 155 of the individual service provider for a given time interval, such as a current session interval of the service provider. The remedial actions may be selected based on type and/or the satisfaction score 155, as well as the profile of the service provider. By way of example, the remediation component 160 may utilize the satisfaction score 155 to determine whether the service provider met a threshold for receiving a remedial action. As an addition or alternative, the remediation component 160 may utilize the satisfaction score 155 to select a type of remedial action. The type of remedial action may correspond to, for example, the service provider being provided a weight 167 (e.g., via account/profile store 164), which the matching component 130 can use to increase the likelihood that the service provider receives an assignment in an upcoming duration of time. As an addition or variation, the remediation component 160 may select the remedial action to correspond to a value 169 (e.g., monetary or service credit), which can be associated with an account 165 of the service provider, as maintained in an account/profile store 164. Still further, another service action 171 may be designated on behalf of the service provider, such as eliminating certain destinations from matched assignments of the service provider for a given duration of time.

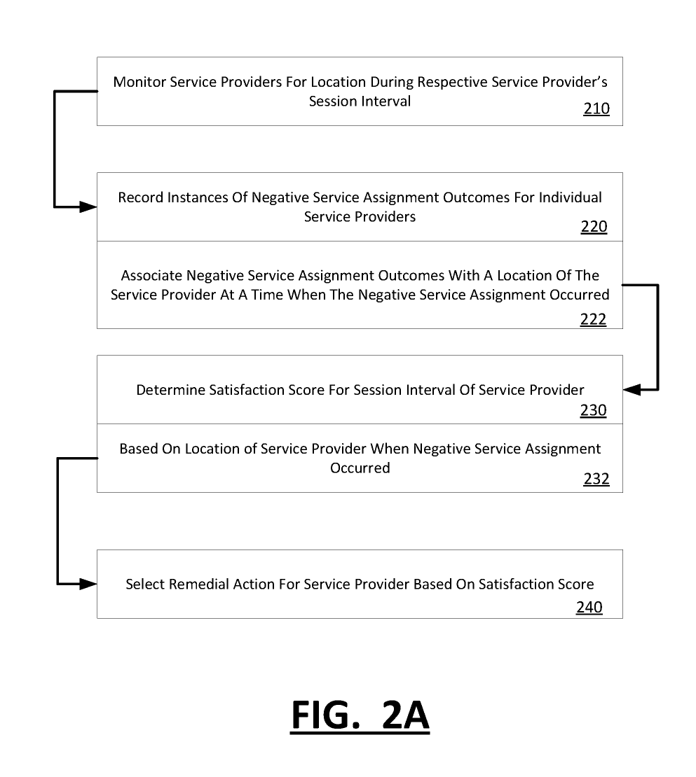

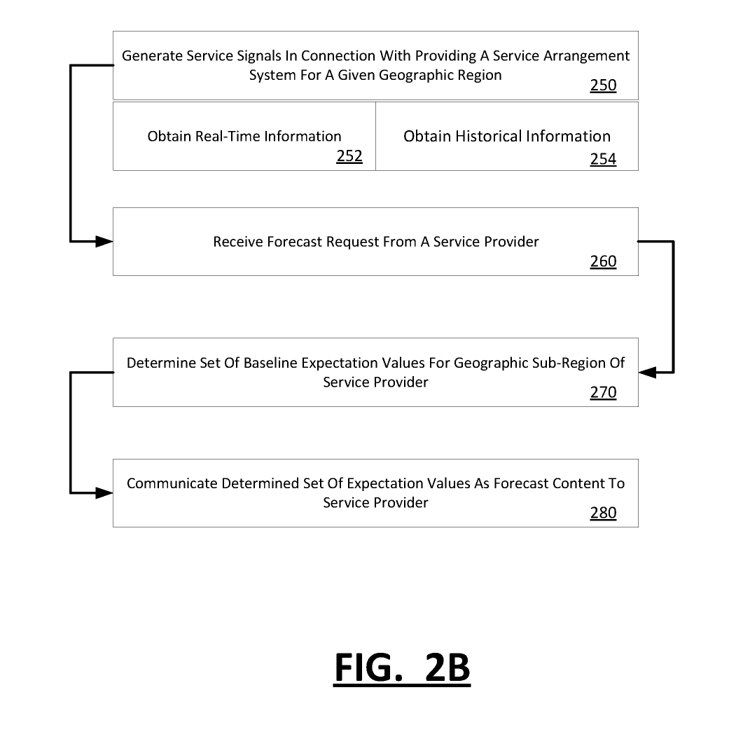

FIG. 2A illustrates an example method for implementing a service arrangement system to detect negative service assignment outcomes. FIG. 2B illustrates an example method for providing forecasts of service provider objectives for an upcoming interval of time. As described, examples of FIG. 2A and FIG. 2B may be implemented using functionality and components described with an example of FIG. 1. Accordingly, reference may be made to elements of FIG. 1 for purpose of illustrating a suitable step or sub-step being described with examples of FIG. 2A and FIG. 2B.

With reference to FIG. 2A, system 100 monitors individual service providers to determine a location of each service provider at multiple instances of the respective service provider's session interval (210). In some examples, the service application 106 of the service provider may communicate information, including the current location of the service provider, to the network computing system 100. Thus, for example, the service data store 140 may record a current location of the service provider via the communications of the service application 106.

The network computing system 100 may record one or more negative service assignment outcomes of individual service providers over their respective session intervals (220). The negative service assignment outcome may be predefined, to reflect, for example, a service assignment that is subsequently canceled, a just-missed service assignment, or a service assignment with an undesirable service parameter (e.g., destination). In other examples, the negative service assignment outcome may be predefined as an event in which individual service providers are assigned to a service request that is deemed to diminish an earning of the respective service provider over the service session interval as compared to a baseline. By way of example, the baseline may correspond to a majority of other service requests which were assigned to other service providers in a predetermined vicinity of the first service provider at the time when the service request is received.

In some examples, the negative service assignment outcomes may be associated with a location of the service provider at a time when the negative service assignment outcome occurred (222). For example, the location may correspond to the location of the service provider when a just-missed service assignment outcome occurred. Alternatively, the location may coincide with the location of the service provider at the time when a service cancelation occurred. Still further, the location associated with the negative service assignment outcome may correspond to an undesirable destination of a service assignment.

According to some examples, the network computing system 100 may determine a satisfaction score for the service session interval based at least in part on the recorded negative service assignment outcomes (230). In some examples, the satisfaction score may be based at least in part on the location of the service provider at the time when the negative service assignment outcome occurred (232). For example, the network computing system 100 may determine the satisfaction score to reflect a greater degree of dissatisfaction if the service provider is located in a region where there is relatively high demand, because the missed opportunity represented by the unwanted service assignment outcome has a greater impact.

The network computing system 100 may select a remedial action for the service provider based on the satisfaction score (240). For example, the network computing system 100 may select a remedial action for the service provider as a response to a determination that the satisfaction score 155 does not meet a satisfactory threshold. In examples, the satisfactory threshold can be based on whether the satisfaction score meets a predetermined definition of statistical anomality (e.g., a standard deviation), as compared to satisfaction scores of other service providers in the relevant time period and location. If the satisfaction score 155 does not meet the threshold, then one or more one or more types of remedial actions may be performed. Depending on implementation, the remedial action(s) can include one or more of (i) weighting the service provider to receive a service assignment in an upcoming duration, and/or (ii) rewarding the service provider with credit or value. The type and quantity of remuneration (e.g., amount of credit) may be based on the satisfaction score, as well as other considerations such as the type of service assignment outcome, the location of the service provider when the unwanted service assignment outcome occurred, and/or the magnitude of the satisfaction score.

With reference to FIG. 2B, the network computing system 100 generates service signals 159 in connection with providing a service arrangement service for a given geographic region (250). The service signals 159 may be generated from, for example, an aggregation of data which correlate to predefined objectives for service providers. By way of example, the service signals 159 may identify (i) the average time between service requests for service providers that are located within individual sub-regions, (ii) the aggregate number of service requests received or fulfilled by service providers based on sub-regions, (iii) the number of service providers (or available service providers) which are located within individual sub-regions, and/or (iv) the number of active requesters within individual sub-regions, including the number of open requests, and/or the number of requesters who may soon be ready to make a service request (e.g., service requesters who have a service application open for generating a service request). In variations, additional service signals 159 may account for traffic conditions (e.g., amount of congestion on the road), weather conditions (e.g., less service requests may be received in inclement weather), or presence of events where requesters or providers may be conglomerated (e.g., sub-region includes public concert). According to some examples, the service signals are collected in real-time, or near real-time (252). In variations, the service signals are determined from historical sources, such as historical service store 162 (254).

The network computing system 100 may receive a forecast request from a given service provider (260). For example, a service provider may initiate a service session interval by operating the service application 106 to indicate a status of on-line or available. Once launched, the service application 106 may communicate with the network computing system 100 to provide the current location and identifier for the service provider. The service application 106 may also send a forecast request to the network computing system 100.

The information communicated by the service application 106 may also identify the type of service or product that the service provider is eligiible to provide. For example, the service provider can be eligible for providing standard transport and/or deliveries based on the driver's vehicle type. Alternatively, the service provider may be eligible for additional levels of service, based on the service provider's vehicle type, skill level, experience, rating or preference. Thus, for example, a service provider that operates a luxury class vehicle can be eligible for luxury transport service, as well as discount transport service, transport pool, delivery service, or mid-tier service. In such examples, the eligibility of the service provider can also be subject to other criterion, such as the driver's experience or rating. Conversely, another service provider that operates a midsize sedan, including one of similar experience or rating, may be limited in eligibility to discount transport service, transport pool, or delivery service. Still further, the limitations of eligibility may also be based on a preference or setting associated with the particular service provider. For example, a service provider who operates a luxury vehicle may elect to not be eligible for discount service, pools, or deliveries.

In response to the forecast request, the network computing system 100 determines a set of baseline expectation values 157 for the service provider, based on the location of the service provider (270). As described, each baseline expectation value 157 may correspond to a forecasted value that correlates to one or more of the predefined objectives for the service provider. As such, each baseline expectation value 157 may be based at least in part by an aggregation of one or more of the service signals 159. For example, a regression-based model may be used to determine the set of baseline expectation values 157 for the service provider based on an aggregation of service signals 159. Additionally, as a forecasted value, the baseline expectation values 157 may reflect a likelihood (e.g., most probably) and an amount (e.g., projected time until service request is assigned, projected number of service requests that will be assigned to the service provider over an upcoming time interval, etc.). When provided as forecast values, the baseline expectation values 157 may alternatively be implemented to reflect a statistical range.

The network computing system 100 may communicate the determined set of expectation values 157 to the service provider, where the values may be rendered as forecast content (280). By way of example, the forecast content may display information to the provider, such as an expected duration of time until the service provider is assigned a service request, or an amount of earnings which the service provider can expect to receive over an upcoming time interval.

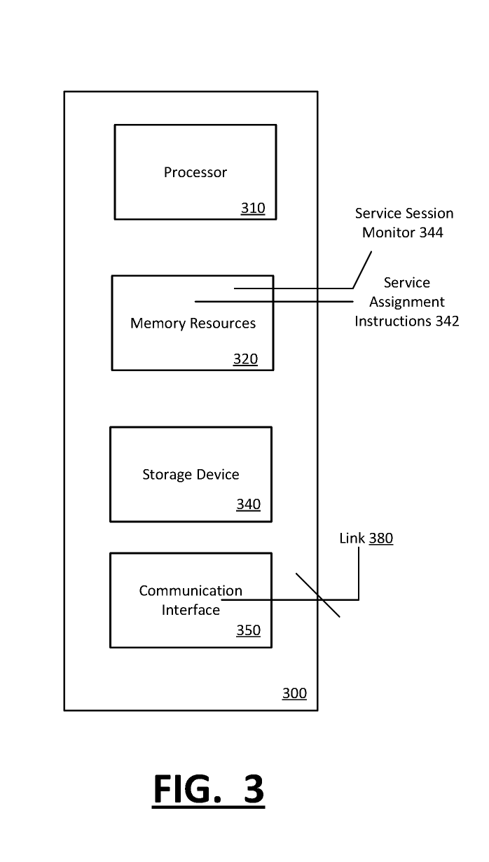

FIG. 3 is a block diagram that illustrates a computer system upon which embodiments described herein may be implemented. A computer system 300 can be implemented on, for example, a server or combination of servers. For example, the computer system 300 may be implemented as part of a network service for providing transport services. In the context of an example of FIG. 1, the computer system 300 may be used to implement the service arrangement system 100, including the service session monitor 150 and remedial component 160. Likewise, computer system 200 may be used to implement a method such as described with an example of FIG. 2A or FIG. 2B.

In one implementation, the computer system 300 includes processing resources 310, memory resources 320 (e.g., read-only memory (ROM) or random-access memory (RAM)), a storage device 340, and a communication interface 350. The computer system 300 includes at least one processor 310 for processing information stored in the main memory 320, such as provided by a random-access memory (RAM) or other dynamic storage device, for storing information and instructions which are executable by the processor 310. The main memory 320 also may be used for storing temporary variables or other intermediate information during execution of instructions to be executed by the processor 310. The computer system 300 may also include the memory resources 320 or other static storage device for storing static information and instructions for the processor 310. A storage device 340, such as a magnetic disk or optical disk, is provided for storing information and instructions.

The communication interface 350 enables the computer system 300 to communicate with one or more networks (e.g., cellular network) through use of the network link 380 (wireless or a wire). Using the network link 380, the computer system 300 can communicate with one or more computing devices, and one or more servers. The executable instructions stored in the memory 330 can include service assignment instructions 342, to implement a service assignment system such as described with an example of FIG. 1. The executable instructions stored in the memory resources 320 may also include service session monitoring instructions 344, to implement functionality described with, for example, service session monitor 150. Likewise, the service arrangement instructions 342 and the service session monitoring instructions 344 may implement a method such as described with an example of FIG. 2A or FIG. 2B.

As such, examples described herein are related to the use of the computer system 300 for implementing the techniques described herein. According to an aspect, techniques are performed by the computer system 300 in response to the processor 310 executing one or more sequences of one or more instructions contained in the main memory 320. Such instructions may be read into the main memory 320 from another machine-readable medium, such as the storage device 340. Execution of the sequences of instructions contained in the main memory 320 causes the processor 310 to perform the process steps described herein. In alternative implementations, hard-wired circuitry may be used in place of or in combination with software instructions to implement examples described herein. Thus, the examples described are not limited to any specific combination of hardware circuitry and software.

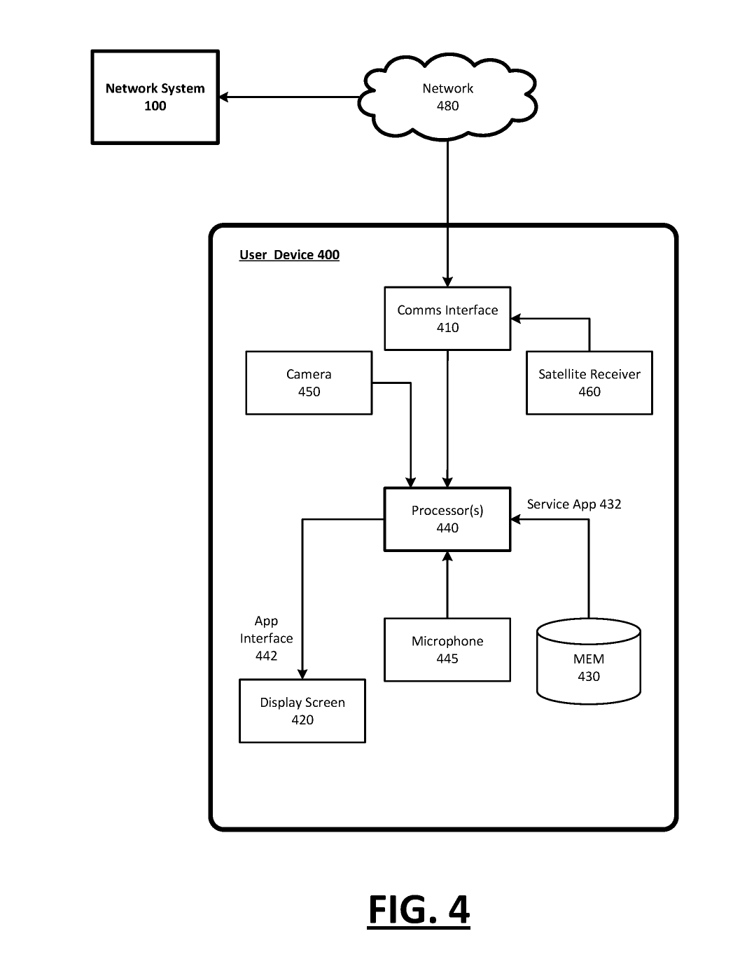

FIG. 4 is a block diagram illustrating an example user device for use with examples as described. In an example, a provider device 400 may execute a designated service application for a network service implemented through the network computing system 100, such as described with an example of FIG. 1. In many implementations, the requester device 400 can include a mobile computing device, such as a smartphone, tablet computer, laptop computer, VR or AR headset device, and the like. As such, the requester device 400 can include typical telephony and/or tablet features such as a microphone 445, a camera 450, a satellite receiver 460, and a communication interface 410 to communicate with external entities using any number of wireless communication protocols. In certain aspects, the requester device 400 can store a designated application (e.g., a service app 432) in a local memory 430. In variations, the memory 430 can store additional applications executable by one or more processors 440 of the requester device 400, enabling access and interaction with one or more host servers over one or more networks 480.

In examples, the requester the service application 432 can interact with the requester device 400 to display an application interface 442 on a display screen 420 of the requester device 400. When the service application 432 is launched, the requester device 400 can operate as (i) an information gathering resource of the network computing system 100, and (ii) an outlet for determinations made by the network computing system 100. Accordingly, the service application 432 may respond to instructions, commands, code sequences, or scripts received over one or more networks, from or for use with the network computing system 100.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is claimed is:

1. A computer system to provide a transport arrangement service, the computer system comprising:
one or more processors;
a set of memory resources to store a set of instructions;
wherein the one or more processors access the set of instructions to:
communicate, over one or more networks, with a plurality of service provider devices, the plurality of service provider devices being operated by a plurality of service providers for the transport arrangement service;
determine a location of each of the plurality of service providers by communicating with a respective service provider device of the plurality of service providers devices, the location of each of the plurality of service provider devices being determined at multiple instances of time during a respective session interval of that service provider;
for at least a first service provider of the plurality of service providers:
record multiple service assignment outcomes of that service provider over the respective session interval, each of the multiple service assignment outcomes being recorded using information obtained by communicating with the respective service provider device of the first service provider, wherein each of the multiple service assignment outcomes is associated with a corresponding location of the first service provider at a time when that service assignment outcome occurred;
determine each service assignment outcome of the multiple service assignment outcomes which qualify as being negative;
determine a satisfaction score for the service session interval of the first service provider based at least in part on each service assignment outcome that is determined to be negative for the first service provider; and
implement a remedial action to benefit the first service provider in response to the determined satisfaction score of the first service provider.

2. The computer system of claim 1, wherein the one or more processors determine a service assignment outcome of the multiple service assignment outcomes to be negative when the first service provider is deemed available and in position to receive a corresponding service request that is subsequently assigned to a second service provider.

3. The computer system of claim 2, wherein the one or more processors determine the service assignment outcome to be negative when the first service provider is determined to have been a candidate for assignment to the corresponding service request as a result of a location of the first service provider being within a threshold distance to a service start location of the service request.

4. The computer system of claim 2, wherein the one or more processors determine the service assignment outcome to be negative if the corresponding service request specifies a service location that is within a predefined geographic area.

5. The computer system of claim 1, wherein the one or more processors determine a service assignment outcome of the multiple service assignment outcomes to be negative when the first service provider is assigned to a corresponding service request that is subsequently canceled by a requester before the requester receives service from the first service provider.

6. The computer system of claim 1, wherein the one or more processors determine a service assignment outcome of the multiple service assignment outcomes to be negative when the first service provider is assigned to a corresponding service request that is deemed to diminish an earning of the first service provider over the service session interval as compared to a majority of other service requests which were assigned to other service providers in a predetermined vicinity of the first service provider at the time the service request is received.

7. The computer system of claim 1, wherein the one or more processors define a service assignment outcome to be negative when the service assignment outcome is an outcome that is likely unwanted by the first service provider.

8. The computer system of claim 1, wherein the one or more processors implement the remedial action by assigning a weight to the first service provider, wherein the weight is to make the first service provider more likely to be assigned to a subsequent service assignment request.

9. The computer system of claim 1, wherein the one or more processors implement the remedial action by forcing assignment of the first service provider to a subsequent service request.

10. The computer system of claim 1, wherein the one or more processors implement the remedial action in response to determining that the satisfaction score of the first service provider qualifies as a predefined statistical anomality, as compared to satisfaction scores of the plurality of service providers.

11. The computer system of claim 1, wherein the one or more processors determine the satisfaction score based at least in part on a number of service request outcomes that are determined to be negative during the service session interval of the first service provider.

12. The computer system of claim 1, wherein the one or more processors determine an aggregation of service assignment outcomes for multiple service providers over a given time period, and wherein the one or more processors determine the satisfaction score based at least in part on the aggregation.

13. The computer system of claim 1, wherein the one or more processors execute the instructions to:
obtain feedback from the first service provider regarding a desirability of a first service assignment outcome of the multiple service assignment outcomes; wherein determining the satisfaction score is based at least in part on the feedback of the first service provider

14. A non-transitory computer-readable medium that stores instructions, which when executed by one or more processors of a computer system, cause the computer system to perform operations that include:
communicating, over one or more networks, with a plurality of service provider devices, the plurality of service provider devices being operated by a plurality of service providers for the transport arrangement service;
determining a location of each of the plurality of service providers by communicating with a respective service provider device of the plurality of service providers devices, the location of each of the plurality of service provider devices being determined at multiple instances of time during a respective session interval of that service provider;
for at least a first service provider of the plurality of service providers:
recording multiple service assignment outcomes of that service provider over the respective session interval, each of the multiple service assignment outcomes being recorded using information obtained by communicating with the respective service provider device of the first service provider, wherein each of the multiple service assignment outcomes is associated with a corresponding location of the first service provider at a time when that service assignment outcome occurred;
determining each service assignment outcome of the multiple service assignment outcomes which qualify as being negative;
determining a satisfaction score for the service session interval of the first service provider based at least in part on each service assignment outcome that is determined to be negative for the first service provider; and
implementing a remedial action to benefit the first service provider in response to the determined satisfaction score of the first service provider.

15. A method for arranging services, the method being implemented by one or more processors and comprising:
communicating, over one or more networks, with a plurality of service provider devices, the plurality of service provider devices being operated by a plurality of service providers for the transport arrangement service;
determining a location of each of the plurality of service providers by communicating with a respective service provider device of the plurality of service providers devices, the location of each of the plurality of service provider devices being determined at multiple instances of time during a respective session interval of that service provider;
for at least a first service provider of the plurality of service providers:
recording multiple service assignment outcomes of that service provider over the respective session interval, each of the multiple service assignment outcomes being recorded using information obtained by communicating with the respective service provider device of the first service provider, wherein each of the multiple service assignment outcomes is associated with a corresponding location of the first service provider at a time when that service assignment outcome occurred;
determining each service assignment outcome of the multiple service assignment outcomes which qualify as being negative;
determining a satisfaction score for the service session interval of the first service provider based at least in part on each service assignment outcome that is determined to be negative for the first service provider; and
implementing a remedial action to benefit the first service provider in response to the determined satisfaction score of the first service provider.

16. A computer system comprising:
one or more processors;
a set of memory resources to store a set of instructions;
wherein the one or more processors access the set of instructions to:
obtain service signals, in connection with matching service providers to service requests in a given geographic region, the service signals correlating to a set of predefined objectives for service providers;
receive a forecast request from a service provider, the service provider being associated with a sub-region of the geographic region;
determine a set of baseline expectation values for the service provider, based at least in part on the obtained service signals; and
communicate the set of baseline expectation values to the service provider as forecast content.

17. The computer system of claim 16, wherein the determined set of baseline expectation values includes a first baseline expectation value that is based at least in part on a likely duration of time until the service provider is assigned to a service request.

18. The computer system of claim 16, wherein the determined set of baseline expectation values includes a first baseline expectation value that is based at least in part on a likely number of service requests which the service provider will receive in an upcoming interval of time.

19. The computer system of claim 16, wherein the determined set of baseline expectation values includes a first baseline expectation value that is based at least in part on a likely earning that the service provider will make over an upcoming time interval.

20. The computer system of claim 16, wherein the service signals are obtained in near real-time.
